(19) United States
(12) Patent Application Publication
(10) Pub. No.: US 2004/0179850 A1
(43) Pub. Date: Sep. 16, 2004

(54) Wavelength dispersion compensation system

(75) Inventors: Toru Katagiri, Kawasaki (JP); Kenichi Torii, Tokyo (JP); Toshiki Tanaka, Kawasaki (JP); Takao Naito, Kawasaki (JP); Kouichirou Amemiya, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/777,675

(22) Filed: Feb. 13, 2004

(30) Foreign Application Priority Data
Mar. 11, 2003 (JP) 2003-065604

(51) Int. Cl. H04B 10/12

(52) U.S. Cl. 398/147

(57) ABSTRACT

A span between an optical transmitting end station and an optical repeater node, a span between optical repeater nodes, a span between an optical repeater node and a receiving end station, and a span between an optical repeater node and a CN/OADM/HUB node are set as first dispersion compensation sections. Additionally, a span between the optical transmitting end station and a CN/OADM/HUB node, a span between CN/OADM/HUB nodes, and a span between a CN/OADM/HUB node and the receiving end station are set as second dispersion compensation sections. In the first dispersion compensation sections, dispersion compensation is made so that residual dispersion becomes a predetermined negative value. In the second dispersion compensation sections, dispersion compensation is made so that residual dispersion becomes a positive value.

### BACKGROUND OF THE INVENTION

1. Field of the Invention

The present invention relates to wavelength dispersion compensation in a wavelength division multiplexing transmission system.

2. Description of the Related Art

With a rapid increase in data traffic which typifies IP traffic, the demand for a transmission system with which a large-capacity and flexible network is built at low cost has been rising. One resolution to such a demand is an increase in the distance and the capacity of an optical WDM (Wavelength Division Multiplexing) transmission system having an optical add/drop function. Especially, moves are currently afoot to introduce a WDM system of 40 Gbps per wavelength in addition to an already commercialized WDM system of 10 Gbps per wavelength. However, a big difference exists between the dispersion tolerance at a receiving end of a WDM signal of 10 Gbps per wavelength and that of a WDM signal of 40 Gbps per wavelength. Therefore, if both of the signals are attempted to be transmitted in one system, an optimum dispersion compensation system must be built.

Normally, an optical signal transmitted by being wavelength division multiplexed undergoes wavelength dispersion while it propagates through an optical fiber, which is a transmission line. The wavelength dispersion means that a difference occurs between the transmission rates of light beams having different wavelengths due to the dependency of the refractive index of an optical fiber on a wavelength. If an optical signal having a certain bandwidth propagates through an optical fiber having wavelength dispersion, optical modulation widens a pulse waveform, and deteriorates the quality of transmission due to wavelength distortion, so that a transmission distance in a WDM transmission system is restricted. Especially, in a long-distance WDM transmission system using an optical amplifier typified by an EDFA (Erbium Doped Fiber Amplifier) or a DRA (Distributed Raman Amplifier) that has been being briskly studied in recent years, signal light is transmitted from a transmitting end station to a receiving end station unchanged as light. Therefore, wavelength dispersion in a transmission line accumulates. Patent Document 1 discloses a technique, which inserts a wavelength dispersion compensator such as a DCF (Dispersion Compensation Fiber), etc. at appropriate intervals in order to satisfy the requirement to reduce accumulated wavelength dispersion to a predetermined value or less, as a technique for suppressing the above described waveform distortion.

Additionally, the WDM transmission system has a problem that accumulated wavelength dispersion may differ depending on each signal light wavelength due to an influence of the dispersion slope of a transmission line. To address this problem, configuration where a dispersion compensation fiber of a slope compensation type, which compensates for both the wavelength dispersion and the dispersion slope of a transmission line, is used in a WDM transmission system is proposed by Patent Document 1.

FIGS. 1A and 1B show a conventional example of a WDM transmission system using a dispersion compensation fiber of a slope compensation type, which compensates for both the wavelength dispersion and the dispersion slope of a transmission line.

FIG. 1A shows a block diagram of a WDM transmission system where a transmission line fiber, and a dispersion compensation fiber of a slope compensation type, which compensates for both the wavelength dispersion and the dispersion slope of the transmission line fiber are used in each optical amplifier/repeater section. FIG. 1B shows an accumulated wavelength dispersion to transmission distance characteristic of the WDM transmission system shown in FIG. 1A. In the WDM transmission system shown in FIG. 1A, light beams output from optical transmitters (OSes in FIG. 1A) of respective wavelengths are wavelength-multiplexed by an optical multiplexer 10, and output to a transmission line 12 after being signal-amplified by an optical amplifier 11 unchanged as light. Since the WDM signal propagates while undergoing the influence of wavelength dispersion and the dispersion slope of the transmission line optical fiber 12, accumulated dispersion of each wavelength at a point a, c, e, g, . . . or z of FIG. 1B varies in an output of the transmission line. An optical amplifier/repeater node comprises a dispersion compensation fiber 14 of a slope compensation type (DCM in FIG. 1A), which compensates for both the accumulated wavelength dispersion and the dispersion slope of the transmission line optical fiber 12. Accordingly, as indicated by a point b, d, f, or h in FIG. 1B, accumulated dispersion of each wavelength becomes zero for each optical amplifier/repeater node. As the dispersion compensation fiber of a slope compensation type 14, an optical fiber whose wavelength dispersion and dispersion slope polarities have characteristics reverse to the transmission line optical fiber is used. However, due to the influence of nonlinear effects possessed by an optical fiber, the optical fiber has a characteristic that a target value of accumulated wavelength dispersion after a transmission slightly shifts from zero to a positive or negative accumulated dispersion value.

Furthermore, if a long-distance transmission is considered in this conventional example, accumulated wavelength dispersion in each optical amplifier/repeater section becomes zero, and the phase of a transmission pulse of each wavelength is regenerated in each optical amplifier/repeater output. Accordingly, waveform distortion is caused by the influence of XPM (Cross Phase Modulation), which is one of the nonlinear effects of an optical fiber, so that the transmission distance of a WDM signal is restricted.

Namely, if a value of wavelength dispersion given to an optical signal in a transmission line is completely compensated and reduced to 0, timing of an optical signal having each wavelength becomes the same timing transmitted from an optical transmitter OS. This increases the possibility that an optical pulse portion corresponding to logic “1” of an optical signal matches an optical pulse portion corresponding to logic “1” of an optical signal having a different wavelength. The cross phase modulation causes a phenomenon that a refractive index within a fiber changes with the intensity of light having a different wavelength, an optical signal having other wavelength is phase-modulated, so that a waveform is distorted in combination with the wavelength dispersion of an optical fiber. Accordingly, if the timing of the pulse of an optical signal having one wavelength matches the timing of the pulse of an optical signal having another wavelength, an optical pulse the intensity of which is high runs together at the same timing. This makes it easier to exert the influence of cross phase modulation of an optical pulse having one wavelength on an optical pulse having another wavelength, which leads to a deterioration of an optical waveform. In the meantime, if wavelength dispersion is slightly left, the timing of the pulse of an optical signal having one wavelength slightly shifts from that of the pulse of an optical signal having another wavelength due to a propagation delay difference. This can decrease the degree of influence of cross phase modulation of the optical signal having one wavelength, which is exerted on the optical signal having another wavelength. However, the above described effect can be achieved only for a signal whose bit rate per wavelength is 10 G bps. For a signal whose bit rate per wavelength is 40 G bps, its dispersion tolerance at a receiving end is very small. Therefore, the signal cannot be properly received unless the value of residual dispersion is reduced to 0 eventually.

Patent Document 2 proposes a dispersion compensation method with which an average wavelength dispersion value of an entire system is reduced to a small value, which is not 0, in order to maintain a balance between the wavelength dispersion and the nonlinear effects of an optical fiber in consideration of a long-distance transmission.

FIG. 2 shows a conventional example of a dispersion compensation method with which accumulated wavelength dispersion is compensated in two different cycles, and an average wavelength dispersion value of an entire system is not 0.

FIG. 2A shows a block diagram of a WDM transmission system using a transmission line fiber, and a dispersion compensation fiber of a slope compensation type, which compensates for both the wavelength dispersion and the dispersion slope of the transmission line fiber, in each optical amplifier/repeater section. FIG. 2B shows an accumulated wavelength dispersion to transmission distance characteristic of the WDM transmission system shown in FIG. 2A.

In the WDM transmission system shown in FIG. 2A, light beams output from optical transmitters (OSes in FIG. 2A) of respective wavelengths are wavelength-multiplexed by an optical multiplexer 10, and output to a transmission line 12 after being signal-amplified by an optical amplifier 11 unchanged as light. The WDM signal is wavelength-demultiplexed by an optical demultiplexer 13 at a receiving end station after propagating through a transmission line configured by connecting optical amplifier/repeaters which are composed of a dispersion compensator of a slope compensation type and an optical amplifier, and the demultiplexed light beams are received by optical receivers (ORs in FIG. 2A) of respective wavelengths.

This system has two different dispersion compensation sections: a first dispersion compensation section composed of an optical transmission line fiber and a dispersion compensation fiber of a slope compensation type in each optical amplifier/repeater section, and a second dispersion compensation section composed of a plurality of first dispersion compensation sections. Additionally, a wavelength dispersion compensation target (referred to as a first dispersion compensation target) for a first dispersion compensation section, and a wavelength dispersion compensation target (referred to as a second dispersion compensation target) for a second dispersion compensation section are respectively set, and the second dispersion compensation target is set to be a value smaller than the first dispersion compensation target.

Spans between optical amplifier/repeaters, which are shown in FIG. 2B and represented by 0-b, b-d, d-f, . . . are first dispersion compensation sections. In each of the sections, dispersion compensation is made so that a residual dispersion value at the exit of each of the dispersion compensation sections becomes D_{local}×L, which is a multiplication of a slope D_{local} and a transmission distance L. Additionally, a span indicated by the section 0-1 is a second dispersion compensation section, in which a residual dispersion value at the exit of this dispersion compensation section becomes D_{average}×L, which is a multiplication of a slope D_{average} and a transmission distance L. Additionally, for a long-distance transmission exceeding 1000 km, the nonlinear effects of an optical fiber exert not a little influence on an optical signal as described above. It is proved to be advantageous in terms of an optical transmission characteristic that the average wavelength dispersion value D_{average} of the entire system is reduced to a value, which is not 0, also for the balance maintained between the influence of wavelength dispersion and the influence of the nonlinear effects, which are exerted on an optical signal. Therefore, D_{local} and D_{average} are made to take positive values.

With such a configuration, the wavelength dispersion value of an entire transmission system can be reduced while increasing the wavelength dispersion value between optical amplifier/repeaters. Accordingly, pulses of wavelengths are out of phase in an optical amplifier output (timing at which an optical pulse propagates is shifted depending on a wavelength due to the existence of residual dispersion as described above), so that a deterioration of a transmission characteristic caused by the influence of XPM, which is a nonlinear effect of an optical fiber, can be suppressed, leading to an improvement in the transmission characteristic.

Furthermore, in each optical amplifier/repeater section, an occurred wavelength dispersion compensation error can be compensated in a second wavelength dispersion section, thereby facilitating distributed management.

[Patent Document 1]

Japanese Patent Application Publication No. HEI6-11620

[Patent Document 2]

Japanese Patent Application Publication No. 2000-261377

In the conventional example shown in FIGS. 2A and 2B, a single-mode fiber (SMF) having a zero dispersion wavelength in a 1.3-μm band is used as an optical fiber for transmission. The wavelength dispersion value of the SMF is +17 ps/nm/km in the neighborhood of a wavelength of 1.550 μm, which is a transmission wavelength band of an optical signal. If the length of a transmission line in an optical amplifier/repeater section is 100 km, accumulated wavelength dispersion of the SMF in one repeater section is +1700 ps/nm/km. Although most of the accumulated wavelength dispersion is compensated in a first dispersion compensation section, wavelength dispersion by D_{local}×L, which is shown in FIG. 2B, accumulates. For example, if L=500 km, and if D_{local}=+1 ps/nm/km, D_{local}×L=+500 ps/nm is obtained, so that residual dispersion after an optical signal propagates through the SMF by 100 km following the 500 km results in +2200 ps/nm. Such large wavelength dispersion and SPM (Self Phase Modulation), which is one of the nonlinear effects of an optical fiber, significantly distort a transmission waveform, so that a transmission distance is restricted. Namely, the spectrum of an optical signal is widened by SPM. Here, if the influence of wavelength dispersion exists, the optical signal undergoes the wavelength dispersion in a wide range of the spectrum. Accordingly, it is desirable to suppress the influence of wavelength dispersion given to the optical signal to a small value in a transmission line.

This problem is more noticeable, for example, in a system whose optical amplifier/repeater intervals are taken as 80 km or longer in order to reduce the cost of the optical transmission system, and which connects the East Coast and the West Coast of the North America.

### SUMMARY OF THE INVENTION

An object of the present invention is to provide a system optimally compensating for wavelength dispersion while capturing optical signals having different bit rates.

A wavelength dispersion compensation system according to the present invention comprises: an optical transmitting end station wavelength-multiplexing optical signals, and outputting a wavelength-multiplexed signal to a transmission line; a plurality of first optical repeater nodes arranged on the transmission line; and at least one second optical repeater node, which is arranged among the plurality of first repeater nodes arranged on the transmission line, wherein each of the plurality of first optical repeater nodes compensates for dispersion whose value is larger than a value of dispersion which occurs between the optical transmitting end station or an adjacent first optical repeater node or the second optical repeater node and the first optical repeater node itself, and the second optical repeater node compensates for dispersion so that residual dispersion occurs for a value obtained by subtracting a value of dispersion, which is compensated by a first optical repeater node between the optical transmitting end station or a second optical repeater node at a preceding stage and the second optical repeater node itself, from a value of dispersion in a transmission line, which occurs between the optical transmitting end station or the second optical repeater node at the preceding stage and the second optical repeater node itself.

According to the present invention, dispersion compensation is made by leaving an extra amount of residual dispersion in a section, whose distance is short, between first optical repeater nodes, and the like, and by leaving a small amount of residual dispersion in a section, which includes a plurality of first optical repeater nodes and whose distance is long, between an optical transmitting end station and a second optical repeater node, or between second optical repeater nodes in order to cause the residual dispersion to be a value appropriate to a transmission distance. Namely, the maximum value of wavelength dispersion that a wavelength division multiplexed signal undergoes in a transmission line is made small, and dispersion compensation is made by leaving a small amount of residual dispersion in a second repeater node, etc., thereby avoiding a phenomenon that optical pulses are in phase.

In this way, a waveform deterioration caused by both wavelength dispersion and nonlinear effects can be suppressed, and a long-distance transmission can be implemented.

### BRIEF DESCRIPTION OF THE DRAWINGS

FIGS. 1A and 1B show a conventional example of a WDM transmission system using a dispersion compensation fiber of a slope compensation type, which compensates for both the wavelength dispersion and the dispersion slope of a transmission line;

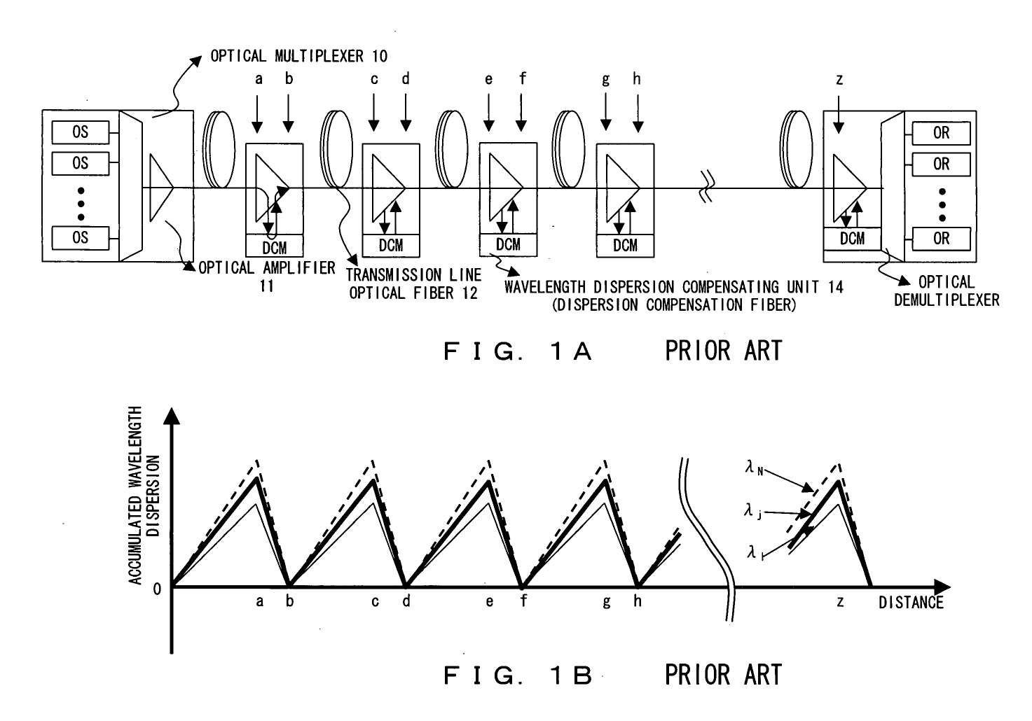

FIGS. 2A and 2B show a conventional example of a dispersion compensation method with which accumulated wavelength dispersion is compensated in different two cycles, and a wavelength dispersion value of an entire system is not zero;

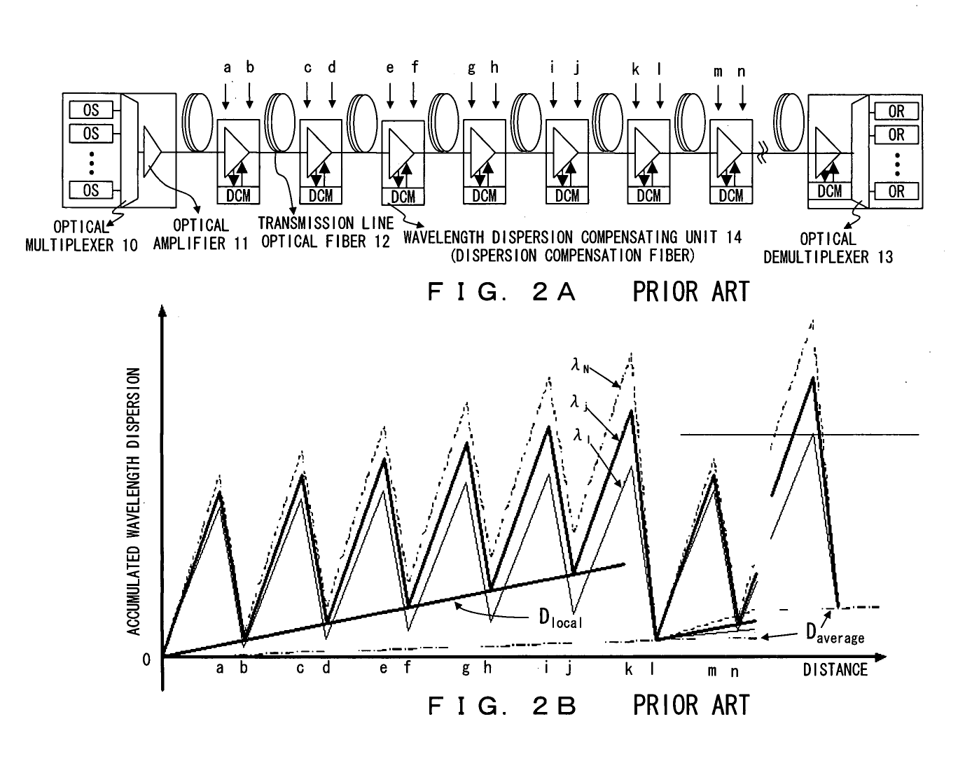

FIG. 3 shows an accumulated wavelength dispersion to transmission distance characteristic of a wavelength dispersion compensation system according to a preferred embodiment of the present invention;

FIGS. 4A and 4B respectively show accumulated wavelength dispersion in the conventional example, and that in the preferred embodiment according to the present invention when the total length of a transmission system is 3000 km;

FIG. 5 shows one example of a WDM transmission system using a wavelength dispersion compensation method according to the present invention;

FIG. 6 shows one example of a WDM transmission network according to a preferred embodiment of the present invention; and

FIG. 7 shows one example of a transmission mode of an optical signal in a WDM transmission system using the wavelength dispersion compensation method according to the present invention.

### DESCRIPTION OF THE PREFERRED EMBODIMENTS

A preferred embodiment according to the present invention provides a wavelength dispersion compensating unit comprising a dispersion compensating unit setting a dispersion compensation target to a transmission distance in a first dispersion compensation section so that accumulated wavelength dispersion becomes negative, and a dispersion compensating unit setting a dispersion compensation target to a transmission distance in a second dispersion compensation section so that accumulated wavelength dispersion becomes positive. As a result, an increase in accumulated wavelength dispersion in a WDM transmission system is suppressed, whereby a preferable transmission characteristic is implemented over a long distance.

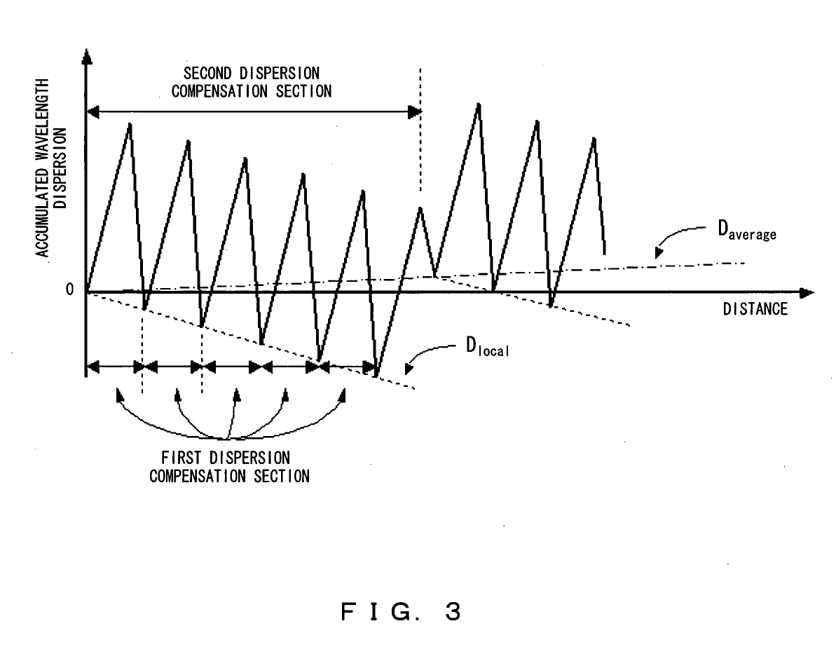

FIG. 3 shows accumulated wavelength dispersion to transmission distance characteristic of a wavelength dispersion compensation system according to the preferred embodiment of the present invention.

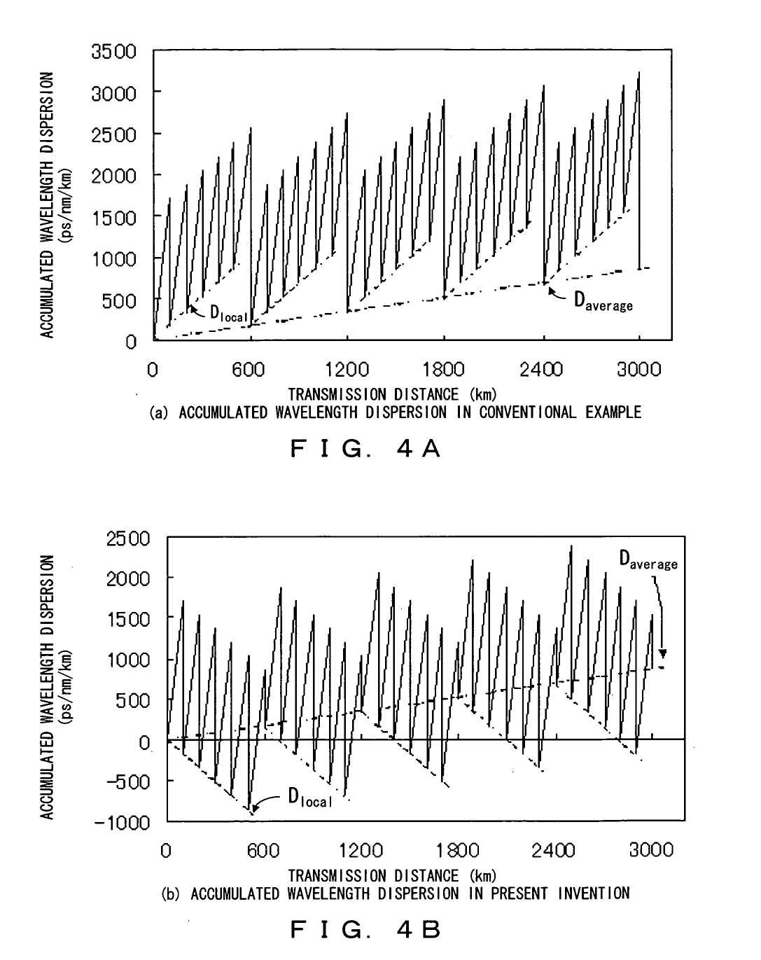

In a first dispersion compensation section composed of an optical transmission line having positive wavelength dispersion, and a dispersion compensator of a slope compensation type, which compensates for both the wavelength dispersion and the dispersion slope of the optical transmission line, a dispersion compensation target is set so that accumulated wavelength dispersion to a transmission distance becomes negative. In FIG. 3, the dispersion compensation target becomes D_{local}×L, which is a multiplication of a slope D_{local} and a transmission distance L. Here, D_{local}<0. In a second dispersion compensation section including a plurality of first dispersion compensation sections, a dispersion compensation target is set so that accumulated wavelength dispersion to a transmission distance becomes positive. In FIG. 3, the dispersion compensation target becomes D_{average}×L, which is a multiplication of a slope D_{average} and a transmission distance L. Here, D_{average}>0. With such a wavelength dispersion compensating unit, a maximum value of wavelength dispersion accumulated in the entire transmission system can be set to a small value. A comparison is made between accumulated dispersion values implemented by the conventional example (FIG. 4A) and by the wavelength dispersion compensating unit according to the preferred embodiment of the present invention as shown in FIG. 4 based on the assumption that the wavelength dispersion of a transmission line is D_{L}=+17 ps/nm/km when a wavelength is 1.55 μm, the length of a transmission line per section is 100 km, and a second dispersion compensation section is 600 km.

Assume that a first dispersion compensation target value in a first dispersion compensation section is set to be D_{local}=1.7 ps/nm/km in the conventional example, and a target value is set to be D_{local}=−1.7 ps/nm/km, which is a reverse polarity, in the preferred embodiment according to the present invention. Also assume that both of second dispersion compensation target values are set to be D_{average}=0.28 ps/nm/km. Accumulated wavelength dispersion in the conventional example, and that in the preferred embodiment according to the present invention when the total length of the transmission system is 3000 km are respectively shown in FIGS. 4A and 4B. As is known from these results, the maximum value of the accumulated wavelength dispersion in the conventional example is +3230 ps/nm, whereas that of the accumulated wavelength dispersion in the preferred embodiment according to the present invention is +2380 ps/nm, which is smaller. With the preferred embodiment, the interaction between SPM and wavelength dispersion can be suppressed, so that distortion of a transmission waveform can be suppressed. Additionally, both of total dispersion compensation amounts of dispersion compensators used in the conventional example and the preferred embodiment according to the present invention are 50150 ps/nm. Even with the use of a wavelength dispersion compensator of a fiber type, nonlinear effects which occur in the dispersion compensators are almost equal. Additionally, since the lengths of the dispersion compensation fibers are the same, their costs are almost equal.

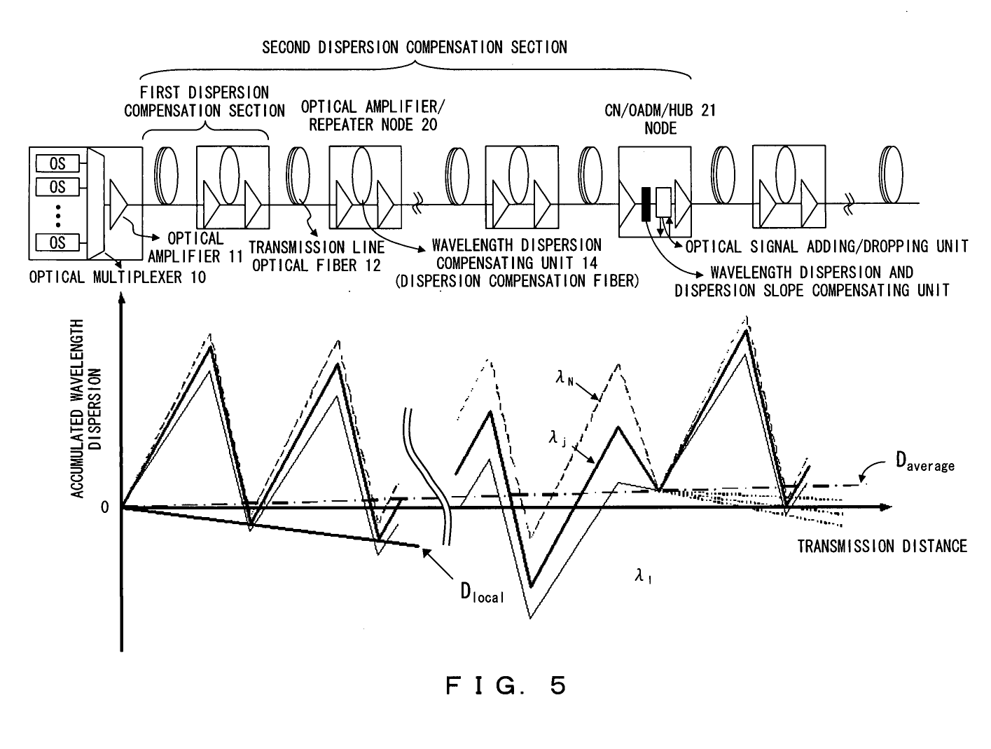

FIG. 5 shows one example of a WDM transmission system using a wavelength dispersion compensation method according to the present invention.

In the WDM transmission system shown in FIG. 5, light beams output from optical transmitters (OSes in FIG. 5) of respective wavelengths are wavelength-multiplexed by an optical multiplexer 10, and input to a transmission line 12 after being signal-amplified by an optical amplifier 11 unchanged as light. After the WDM signal propagates through a transmission line composed of an optical fiber, an optical amplifier/repeater (optical amplifier/repeater node) 20 configured by a dispersion compensation fiber of a slope compensation type and an optical amplifier, a node 21 (hereinafter referred to as a compensation node, which is abbreviated to CN) for compensating for a gain deviation, a compensation error of a wavelength dispersion compensation slope, etc. of the transmission system, which accumulate as a signal proceeds, an OADM (Optical Add Drop Multiplexer) 21 for adding/dropping an optical signal of an arbitrary wavelength from a WDM signal, and a hub node (HUB) 1 for switching the path of light for each arbitrary wavelength, it is received by a receiving end station. At the receiving end station, the signal is wavelength-demultiplexed by an optical demultiplexer, and received by optical receivers (ORs not shown) of respective wavelengths. In this system, a span between an optical transmitting end station and an optical amplifier/repeater node adjacent to the transmitting end station, a span between adjacent optical amplifier/repeater nodes, a span between an optical amplifier/repeater node and a CN/OADM/HUB node adjacent to the repeater node, and a span between an optical amplifier/repeater node and an optical receiving end station adjacent to the repeater node are set as first dispersion compensation sections. Additionally, a span between the optical transmitting end station and the CN/OADM/HUB node, a span between adjacent CN/OADM/HUB nodes, and a span between a CN/OADM/HUB node and an optical receiving end station are set as second dispersion compensation sections. With such a dispersion compensation method, a second dispersion compensation target is set to be accumulated wavelength dispersion which successfully maintains a balance between the wavelength dispersion and the nonlinear effects of a transmission line, even if an optical signal is added/dropped in an OADM/HUB node. As a result, the configuration does not require a wavelength dispersion compensator for each wavelength in the OADM/HUB node, thereby simplifying the configuration of the node, and decreasing the cost of the entire transmission system.

In the schematic showing the accumulated wavelength dispersion to transmission distance in the lower part of FIG. 5, a compensation amount of wavelength dispersion of an optical signal after propagating through the transmission line fiber becomes D_{local}×(transmission distance) in a first dispersion compensation section. Since accumulated wavelength dispersion does not become 0 in this case, accumulated wavelength dispersion that wavelengths λ1 to λN undergo may differ by a wavelength. However, after the WDM signal propagates from the optial transmitting end station 22 to the CN/OADM/HUB node 21, dispersion compensation is made so that residual dispersion becomes D_{average}×(transmission distance) Accordingly, if an optical signal having a particular wavelength is dropped from the WDM signal in the OADM or HUB node 21, the dispersion is compensated to be optimally accumulated residual dispersion in the propagation from the optical transmitting end station 22 to the OADM or HUB node 21. Therefore, for the optical signal which is dropped, dispersion compensation can be continued in a successive manner with a method similar to that shown in the lower part of FIG. 5 even in the propagation after the particular wavelength is dropped. Accordingly, there is no need to provide an extra dispersion compensator for adjusting the dispersion compensation amount after the particular wavelength is dropped.

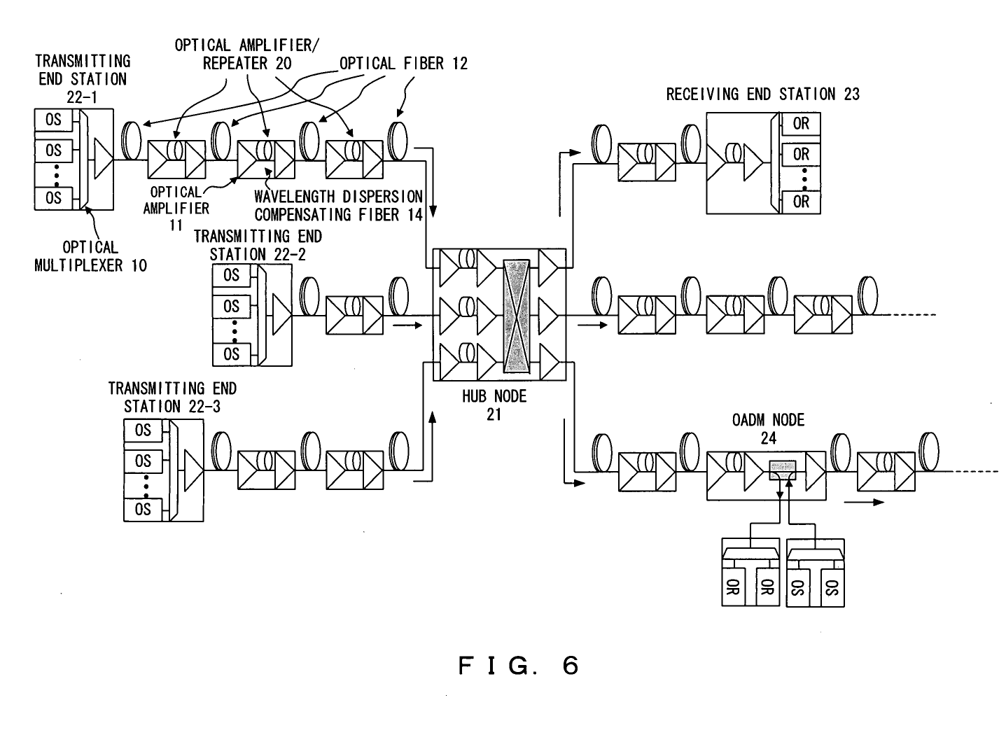

FIG. 6 shows one example of a WDM transmission network according to a preferred embodiment of the present invention.

The network system shown in FIG. 6 is one configuration example for explaining how the dispersion compensation method according to the preferred embodiment of the present invention is applied. A WDM signal transmitted from a transmitting end station 22-1 propagates through a transmission line composed of 4 spans such as a transmission section configured by an optical fiber 12 between the transmitting end station 22-1 and an optical amplifier/repeater 20, transmission sections between optical amplifier/repeaters 20, and a section between the optical amplifier/repeater 20 and the HUB node 21. According to the preferred embodiment of the present invention, these sections are set as first dispersion compensation sections. Accordingly, for dispersion compensation in a transmission section, its residual dispersion is set to a value obtained by multiplying a predetermined negative value D_{local} by a transmission distance from the transmitting end station 22-1. However, the dispersion compensation amount between the optical amplifier/repeater 20 and the HUB node 21 is set so that the residual dispersion becomes a product of the transmission distance from the transmitting end station 22-1 to the HUB node 21 and a predetermined positive value D_{average}. This is because the span between the transmitting end station 22-1 and the HUB node 21 is set as a second dispersion compensation section.

Similarly, also for WDM signals output from transmitting end stations 22-2 and 22-3, dispersion compensation is made so that residual dispersion becomes “a distance of a span×a predetermined negative value D_{local}” as a first dispersion compensation section in each span, according to the preferred embodiment of the present invention. However, spans between the HUB node 21 and the transmitting end station 22-2, and between the HUB node 21 and the transmitting end station 22-3 are second dispersion compensation sections, according to the preferred embodiment of the present invention. Therefore, in the HUB node 21, dispersion compensation is made so that residual dispersion becomes “a transmission distance from the transmitting end station 22-2 or 22-3 to the HUB node 21×a predetermined positive value D_{average}”.

Also dispersion compensation from the HUB node 21 to a receiving end station 23 is similar, and each span is set as a first dispersion compensation section. Therefore, dispersion compensation is made so that residual dispersion becomes “a distance of a span×a predetermined negative value D_{local}” in each span. However, since a span between the HUB node 21 and the receiving end station 23, and a span between the HUB node 21 and an OADM node 24 are set as second dispersion compensation sections according to the present invention, dispersion compensation is made so that residual dispersion becomes “residual dispersion in the HUB node 21+a distance between the HUB node 21 and the receiving end station 23 or the OADM node 24×a predetermined positive value D_{average}” in the receiving end station 23 or the OADM node 24.

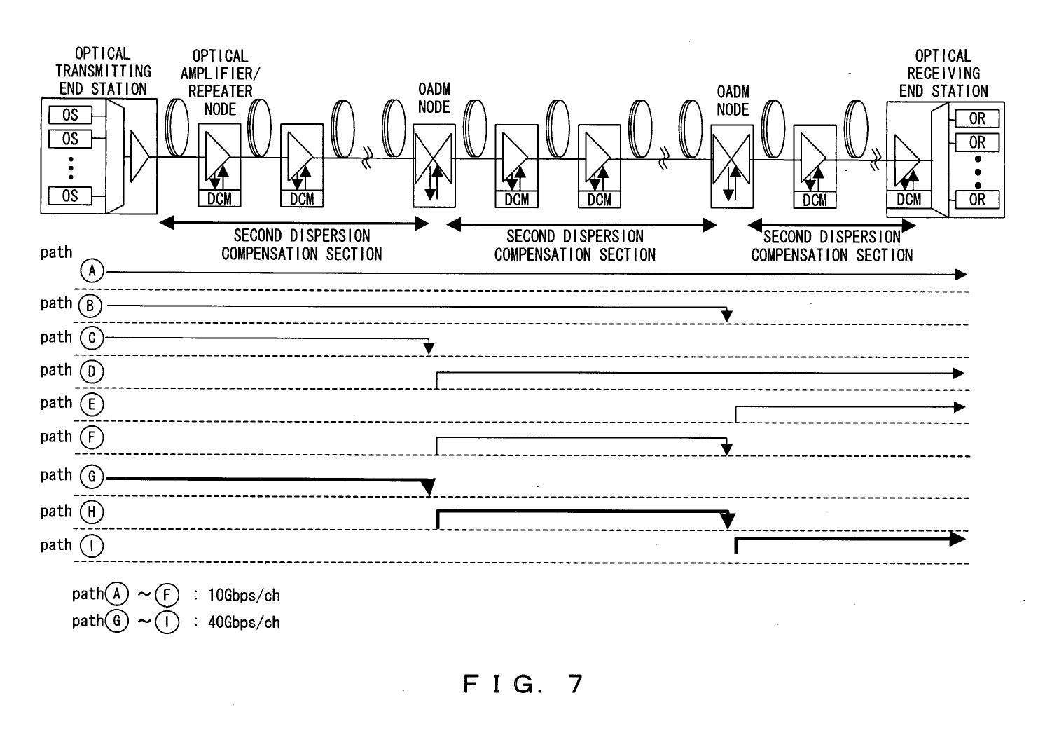

FIG. 7 shows one example of a transmission mode of an optical signal in a WDM transmission system using the wavelength dispersion compensation method according to the present invention.

The system shown in FIG. 7 is a WDM transmission system transmitting an optical signal by combining an optical signal whose bit rate per wavelength is 10 Gbps (such as a SONET OC-192 or SDH STM-64 signal), and an optical signal whose bit rate per wavelength is 40 Gbps (such as a SONET OC-768 signal) in one transmission system. The higher a signal bit rate per wavelength, the more the influence of wavelength dispersion of an optical fiber. Accordingly, accumulated wavelength dispersion at a receiving end must be reduced to a small value that is close to 0. In the WDM transmission system using the wavelength dispersion compensation system according to the preferred embodiment of the present invention, accumulated wavelength dispersion in a first wavelength dispersion compensation section becomes a large value, whereas accumulated dispersion value becomes a small value in a second wavelength dispersion compensation section. Accordingly, an optical signal whose bit rate per wavelength is 40 Gbps can be transmitted in second wavelength dispersion compensation sections between an optical transmitting end station and an OADM node adjacent thereto, between adjacent OADM nodes, and between an OADM node and an optical receiving end station. It is already known that the quality of transmission can be improved by making such settings that accumulated wavelength dispersion becomes a negative wavelength dispersion value in each optical amplifier/repeater section for an optical signal whose bit rate per wavelength is 40 Gbps. It can be said that the wavelength dispersion compensation system according to the preferred embodiment of the present invention is suitable for transmitting a 40-Gbps optical signal, because accumulated wavelength dispersion is made to become a negative wavelength dispersion value in a first wavelength dispersion compensation section.

FIG. 7 shows the example where a WDM signal whose bit rate per wavelength is 10 Gbps is transmitted on paths A to F, and a WDM signal whose bit rate per wavelength is 40 Gbps is transmitted on paths G to H.

As described above, a preferable transmission characteristic can be implemented in a long-distance transmission system according to the present invention. Furthermore, a function for adding/dropping an optical signal is comprised. As a result, a WDM transmission system including an OADM and HUB node, and a WDM transmission system where optical signals whose bit rates per wavelength are respectively 10 and 40 Gbps coexist can be implemented.

What is claimed is:

1. A wavelength dispersion compensation system, comprising:
an optical transmitting end station wavelength-multiplexing optical signals, and outputting a wavelength-multiplexed signal to a transmission line;
a plurality of first optical repeater nodes arranged on the transmission line; and
at least one second optical repeater node, which is arranged among said plurality of first repeater nodes arranged on the transmission line, wherein
each of said plurality of first optical repeater nodes compensates for dispersion whose value is larger than a value of dispersion which occurs between said optical transmitting end station or an adjacent first optical repeater node or an adjacent second optical repeater node and the first optical repeater node itself, and
said second optical repeater node compensates for dispersion so that residual dispersion occurs for a value obtained by subtracting a value of dispersion, which is compensated by a first optical repeater node between said optical transmitting end station or a second optical repeater node at a preceding stage and said second optical repeater node itself, from a value of dispersion in a transmission line, which occurs between said optical transmitting end station or the second optical repeater node at the preceding stage and said second optical repeater node itself.

2. The wavelength dispersion compensation system according to claim 1, wherein
said second optical repeater node is a node which adds/drops an optical signal.

3. The wavelength dispersion compensation system according to claim 1, wherein
said second optical repeater node is a compensation node compensating for again deviation and a compensation error of a wavelength dispersion slope, which accumulate as a wavelength division multiplexed optical signal propagates the system.

4. The wavelength dispersion compensation system according to claim 1, wherein
said second repeater node is a node switching a path of an optical signal for each arbitrary wavelength.

5. The wavelength dispersion compensation system according to claim 1, the system transmitting both of an optical signal whose bit rate per wavelength is 10 Gbps, and an optical signal whose bit rate per wavelength is 40 Gbps.

6. The wavelength dispersion compensation system according to claim 5, wherein
the optical signal whose bit rate per wavelength is 40 Gbps is used only for a transmission between said optical transmitting end station and a particular node, between particular nodes, or between a particular node and an optical receiving end station.

7. A wavelength dispersion compensation method, which has an optical transmitting end station wavelength-multiplexing optical signals and outputting a wavelength-multiplexed signal to a transmission line, a plurality of first optical repeater nodes arranged on the transmission line, and at least one second optical repeater node, which is arranged among the plurality of first repeater nodes arranged on the transmission line, comprising:
compensating for dispersion whose value is larger than a value of dispersion which occurs between the optical transmitting end station or an adjacent first optical repeater node or an adjacent second optical repeater node and the first optical repeater node itself, by each of the plurality of first optical repeater nodes; and
compensating for dispersion so that residual dispersion occurs for a value obtained by subtracting a value of dispersion, which is compensated by a first optical repeater node between the optical transmitting end station or a second optical repeater node at a preceding stage and the second optical repeater node itself, from a value of dispersion in a transmission line, which occurs between the optical transmitting end station or the second optical repeater node at the preceding stage and the second optical repeater node itself, by the second optical repeater node.

8. The wavelength dispersion compensation method according to claim 7, wherein
the second optical repeater node is a node which adds/drops an optical signal.

9. The wavelength dispersion compensation method according to claim 7, wherein
the second optical repeater node is a compensation node compensating for a gain deviation and a compensation error of a wavelength dispersion slope, which accumulate as a wavelength division multiplexed optical signal propagates the system.

10. The wavelength dispersion compensation method according to claim 7, wherein
the second repeater node is a node switching a path of an optical signal for each arbitrary wavelength.

11. The wavelength dispersion compensation method according to claim 7, the system transmitting both an optical signal whose bit rate per wavelength is 10 Gbps, and an optical signal whose bit rate per wavelength is 40 Gbps.

12. The wavelength dispersion compensation method according to claim 11, wherein
the optical signal whose bit rate per wavelength is 40 Gbps is used only for a transmission between the optical transmitting end station and a particular node, between particular nodes, or between a particular node and an optical receiving end station.
